(19) United States
(12) Patent Application Publication
(10) Pub. No.: US 2010/0330255 A1
(43) Pub. Date: Dec. 30, 2010

(54) METHOD OF PREPARING A SHELF STABLE MEAT PRODUCT

(76) Inventor: James Daniel Shull, Coquille, OR (US)

Correspondence Address: ZARLEY LAW FIRM P.L.C., CAPITAL SQUARE, 400 LOCUST, SUITE 200, DES MOINES, IA, 50309-2350, US

(21) Appl. No.: 12/875,335

(22) Filed: Sep. 3, 2010

Related U.S. Application Data
(63) Continuation-in-part of application No. 12/192,297, filed on Aug. 15, 2008, now abandoned.

(51) Int. Cl. A23L 1/314

(52) U.S. Cl. 426/641

(57) ABSTRACT

A method of preparing a shelf stable meat product includes mixing a brine solution and then adding the brine solute to a meat product. The meat product is then cooked to have a water activity of less than 0.85 and packaged in a material having low oxygen and moisture vapor transmission rate. The packaged product is then pasteurized.

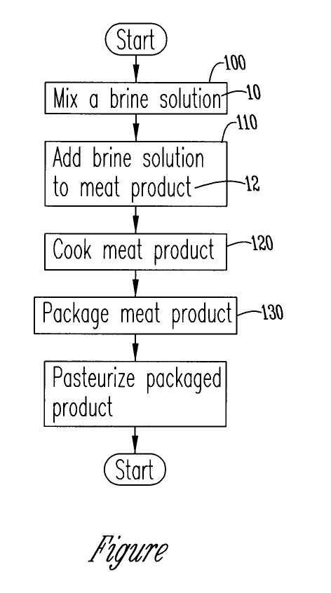

### CROSS REFERENCE TO A RELATED APPLICATION

This application is a continuation-in-part of U.S. patent application Ser. No. 12/192,297 filed Aug. 15, 2008.

### BACKGROUND OF THE INVENTION

This invention relates to a method for processing meat products and other ingredients to produce a fully cooked or oven roasted shelf stable meat product. Further, this invention relates to a method comprising a series of mixing, injecting and/or tumbling, cooking or roasting, chilling, packaging, and pasteurization resulting in a fully cooked or oven roasted meat product that has a taste and texture similar to that of freshly cooked or roasted meat. Said product will remain free from pathogen-causing levels of bacteria and can be stored for an extended period of time without refrigeration due to antimicrobial properties of the ingredients used.

Approximately two-thirds of the world population does not have access to refrigeration for storing food products that would be lost due to spoilage without refrigeration. As a result, this group of the world population does not have access to consuming meat products that require refrigeration. All meat products contain meat proteins that are a source of good nutrition in the human diet. Meat and meat products have historically been an important part of the diet in parts of the world where refrigeration is common. The method and product described herein provides a source of meat protein that has an extended shelf life without refrigeration and also a texture and flavor similar to that of a freshly cooked or roasted meat product. Other flavoring ingredients can be added to provide products for acceptance within a particular culture.

USDA has certain government regulations that must be met for a product to be classified as shelf stable. Good Manufacturing Practices that will provide for a shelf stable product must be met in other areas of the world where USDA does not have jurisdiction. Shelf stable meat products must be able to be stored for extended periods of time without refrigeration without compromising product quality and flavor due to microbial deterioration or oxidative reduction. For a shelf stable meat product to be safe for consumption, the product should be able to inhibit mold and yeast growth, reduce the growth rates of microorganisms present, and inhibit the growth of new bacteria. The shelf stable meat product must maintain a favorable taste.

The term “shelf stable product” refers to a product that is preferred to have a mouth feel and texture that is similar in mouth feel and texture to freshly cooked product. The product must exhibit properties that enable the product to resist significant levels of microbial growth when stored without refrigeration for an extended period of time. The shelf stable product depends on the amount of moisture available for microorganism growth and nutritive support, on the pH of the product, on the oxygen availability, and on the proper initial cooking conditions among other elements. The proper selection of ingredients used to manufacture the product is also important.

Despite these advances in shelf stable meat products, problems still remain. In particular, problems regarding providing a shelf stable meat product with a texture and flavor similar to that of freshly cooked or roasted meat have not been addressed.

Thus, it is a primary object of the present invention to provide a source of meat product that has an extended shelf life without refrigeration that improves upon the state of the art.

Another object of the present invention is to provide a meat product having a texture and flavor similar to that of a freshly cooked or roasted meat.

These and other objects, features, or advantages of the present invention will become apparent from the specification and the claims.

### BRIEF SUMMARY OF THE INVENTION

A method of preparing a shelf stable meat product includes mixing a brine solution and then adding the brine solute to a meat product. The meat product is then cooked to have a water activity of less than 0.85 and packaged in a material having low oxygen and moisture vapor transmission rate. The packaged product is then pasteurized.

### BRIEF DESCRIPTION OF THE DRAWINGS

The FIGURE is a flow diagram of a method of preparing a shelf stable meat product.

### DETAILED DESCRIPTION OF THE PREFERRED EMBODIMENT

Referring to the figures, the method of preparing a shelf stable meat product begins at step 100 by mixing a brine solution 10. Preferably, the brine solution 10 includes water, salt, sodium nitrite, sodium erythorbate, sodium lactate or alternatively potassium lactate, sodium diacetate, and extractive or oregano. Alternatively, the brine solution 10 may also include dextrose or sugar, sodium phosphates, citric acid, lactic acid, and/or sodium ascorbate.

At step 110 the brine solution 10 is added to a meat product 12 in any conventional way such as through injection or tumbling the brine 10 into the meat 12. Once the brine solution 10 is added to the meat product 12, at step 120 the meat product 12 is cooked to reduce its water activity to less than 0.85. Then, to prevent oxidation or dehydration, the cooked meat product is packaged in material having low oxygen and moisture vapor transmission rates such as film packaging at step 130.

To sterilize the packaged meat, at step 140 the packaged meat is pasteurized. The combination of the meat product having a water activity of less than 0.85 and the pasteurization in the package produces a shelf stable product.

Accordingly, a method of preparing a shelf stable meat product has been disclosed that, at the very least, meets the stated objectives.

The sodium nitrite protects against clostridium botulinum which requires pressure cooking to kill. The sodium erythorbate accelerates the process performed by the sodium nitrite. The salt, lactate, and diacetate are preservatives. The extractive of oregano prevents off flavor from the skin. The sodium phosphates prevent warmed over flavor. The salt, dextrose, and sugar are flavor enhancers.

What is claimed is:

1. A method of preparing a shelf stable meat product, comprising the steps of:
mixing a brine solution;
adding the brine solution to a meat product;
cooking the meat product to reduce the water activity of the meat product to less than 0.85;
packaging the cooked meat product in a material having low oxygen and moisture vapor transmission rates; and
pasteurizing the packaged meat product.
